(19) United States
(12) Patent Application Publication
(10) Pub. No.: US 2017/0250451 A1
(43) Pub. Date: Aug. 31, 2017

(54) ON-VEHICLE BATTERY AND ON-VEHICLE POWER SUPPLY DEVICE

(71) Applicant: Murata Manufacturing Co., Ltd., Nagaokakyo-shi (JP)

(72) Inventors: Toru KAWAI, Nagaokakyo-shi (JP); Masanori MORISHITA, Nagaokakyo-shi (JP); Gaku KAMITANI, Nagaokakyo-shi (JP)

(21) Appl. No.: 15/592,434

(22) Filed: May 11, 2017

Related U.S. Application Data
(63) Continuation of application No. PCT/JP2015/081437, filed on Nov. 9, 2015.

(30) Foreign Application Priority Data
Nov. 17, 2014 (JP) 2014-232825

(51) Int. Cl. H01M 16/00; B60R 16/033; F02B 63/04; H01M 10/0525; H01M 2/10; H01M 4/587; H01M 4/38; H01M 4/36; H01M 4/505; H01M 4/525; B60R 16/03; H01M 10/06

(52) U.S. Cl. CPC H01M 16/00; B60R 16/0307; B60R 16/033; F02B 63/04; H01M 10/0525; H01M 10/06; H01M 4/587; H01M 4/386; H01M 4/364; H01M 4/38; H01M 4/505; H01M 4/525; H01M 2/1072; H01M 2220/20

(57) ABSTRACT

An on-vehicle battery includes a lead storage battery and a secondary battery. The secondary battery is connected in parallel with the lead storage battery. The secondary battery 14 has a positive electrode and a negative electrode. The positive electrode includes, as a positive electrode active material, a spinel-type lithium-nickel-manganese oxide. The negative electrode includes, as a negative electrode active material, at least one of graphite, soft carbon, hard carbon, and an alloy-based material containing an Si element.

### CROSS REFERENCE TO RELATED APPLICATIONS

The present application is a continuation of International application No. PCT/JP2015/081437, filed on Nov. 9, 2015, which claims priority to Japanese Patent Applications Nos. 2014-232825, filed on Nov. 17, 2014, the entire contents of each of which are incorporated herein by reference.

### TECHNICAL FIELD

The present invention relates to an on-vehicle battery and an on-vehicle power supply device including the battery.

### BACKGROUND ART

Vehicles are typically equipped with on-vehicle storage batteries for supplying electrical power to various types of electrical loads such as starter motors. Lead storage batteries are used widely as on-vehicle storage batteries.

Lead storage batteries are low in price compared to storage batteries such as lithium ion secondary batteries and nickel-hydrogen batteries. However, lead storage batteries are inferior in resistance to frequent charge/discharge cycles. Therefore, in the case of using only lead storage batteries as on-vehicle storage batteries in vehicles that use large amounts of electricity because of various types of electrical loads, and vehicles provided with idling stop functions and recycling functions for regeneration energy during deceleration, there is concern about early deterioration of the lead storage batteries. Such concerns can be overcome by replacing the lead storage batteries with storage batteries such as lithium ion secondary batteries and nickel-hydrogen batteries. However, in such a case the prices of the on-vehicle storage batteries will be increased.

Japanese Patent Application Laid-Open No. 2011-15516 discloses an on-vehicle storage battery including a secondary storage battery connected in parallel with a lead storage battery without the use of a DC-DC converter interposed therebetween.

There is demand for reducing the size and weight of on-vehicle batteries, while simultaneously reducing an increase in the cost of the on-vehicle batteries for use in on-vehicle power supply devices.

A main object of the present invention is to reduce an on-vehicle battery in size and weight while also reducing an increase in the cost of the on-vehicle battery for use in an on-vehicle power supply device.

### BRIEF DESCRIPTION OF THE INVENTION

One aspect of the invention is a battery comprising a lead storage battery and a lithium ion secondary battery connected in parallel with the lead storage battery. The secondary battery has a positive electrode comprising a positive electrode active material including a spinel-type lithium-nickel-manganese oxide and a negative electrode comprising a negative electrode active material including at least one of graphite, soft carbon, hard carbon, and an alloy-based material containing an Si element.

The battery can include a negative electrode active material consists of at least one of soft carbon, hard carbon, and an alloy-based material containing an Si element. The positive electrode active material may comprise a spinel-type lithium-nickel-manganese oxide of a composition formula Li1+a[Mn2−a−x−yNixMy]O4, M being a metal element containing Ti, 0≦a≦0.3, 0.15≦x≦0.6, and 0≦y≦0.3.

The secondary battery preferably has three secondary batteries connected in series. The capacities of three secondary batteries are preferably equal to each other.

The open circuit voltage of the lead storage battery is preferably coincident with the open circuit voltage of the secondary battery. The lead battery and the secondary battery preferably have a relationship wherein when the open voltages of the lead storage battery and the secondary battery are charged up to a voltage that is higher than their open circuit voltages, the open circuit voltage of the secondary battery is higher than the open circuit voltage of the lead storage battery within the available capacity of the secondary battery.

The secondary battery preferably has a capacity range of 50% or greater in which the open circuit voltage of the secondary battery is equal to or higher than the lower limit of the available open voltage range of the lead storage battery. The secondary battery also preferably has a capacity range of 50% or greater in which the open circuit voltage of the secondary battery is equal to or lower than the charging voltage of the lead storage battery.

The foregoing battery can form part of a power supply device which includes both the battery and a generator connected to the battery.

According to the present invention, while reducing an increase in the cost of the on-vehicle battery for use in an on-vehicle power supply device, the on-vehicle battery can be reduced in size and weight.

### BRIEF EXPLANATION OF DRAWINGS

FIG. 1 is a circuit diagram of an on-vehicle power supply device according to an embodiment of the present invention.

FIG. 2 is a circuit diagram of a secondary battery according to an embodiment of the present invention.

FIG. 3 is a charge/discharge curve of a lithium ion secondary battery obtained by connecting, in series, four lithium ion second batteries using LiNi5/10Co2/10Mn3/10O2 as a positive electrode active material and graphite as a negative electrode active material.

FIG. 4 is a charge/discharge curve of a lithium ion secondary battery obtained by connecting, in series, four lithium ion second batteries using Li4Ti5O12 as a negative electrode active material and a spinel-type lithium-nickel-manganese oxide expressed by a composition formula Li1.1[Ni0.45Mn1.35Ti0.2]O4 as a positive electrode active material.

FIG. 5 is a charge/discharge curve of a secondary battery 14 (lithium ion secondary battery) obtained by connecting, in series, three lithium ion second batteries (unit cells) 14a, 14b, 14c using, for a positive electrode active material, a spinel-type lithium-nickel-manganese oxide expressed by a composition formula Li1.1[Ni0.45Mn1.35Ti0.2]O4, and graphite for a negative electrode active material.

FIG. 6 is a charge/discharge curve of the secondary battery 14 (lithium ion secondary battery) obtained by connecting, in series, the three lithium ion second batteries (unit cells) 14a, 14b, 14c using, for a positive electrode active material, a spinel-type lithium-nickel-manganese oxide expressed by a composition formula Li1.1[Ni0.45Mn1.35Ti0.2]O4, and soft carbon for a negative electrode active material.

FIG. 7 is a charge/discharge curve of the secondary battery 14 (lithium ion secondary battery) obtained by connecting, in series, the three lithium ion second batteries (unit cells) 14a, 14b, 14c using, for a positive electrode active material, a spinel-type lithium-nickel-manganese oxide expressed by a composition formula Li1.1[Ni0.45Mn1.35Ti0.2]0O4, and hard carbon for a negative electrode active material.

FIG. 8 is a charge/discharge curve of the secondary battery 14 (lithium ion secondary battery) obtained by connecting, in series, the three lithium ion second batteries (unit cells) 14a, 14b, 14c using, for a positive electrode active material, a spinel-type lithium-nickel-manganese oxide expressed by a composition formula Li1.1[Ni0.45Mn1.35Ti0.2]O4, and Si for a negative electrode active material.

### PREFERRED EMBODIMENTS

An example of a preferred embodiment of the present invention will be described below. However, the following embodiment is considered by way of example only. The present invention is not limited to the following embodiment in any way. In addition, members that have substantially the same functions shall be denoted by the same reference symbols in the respective drawings referred to in the embodiment and the like.

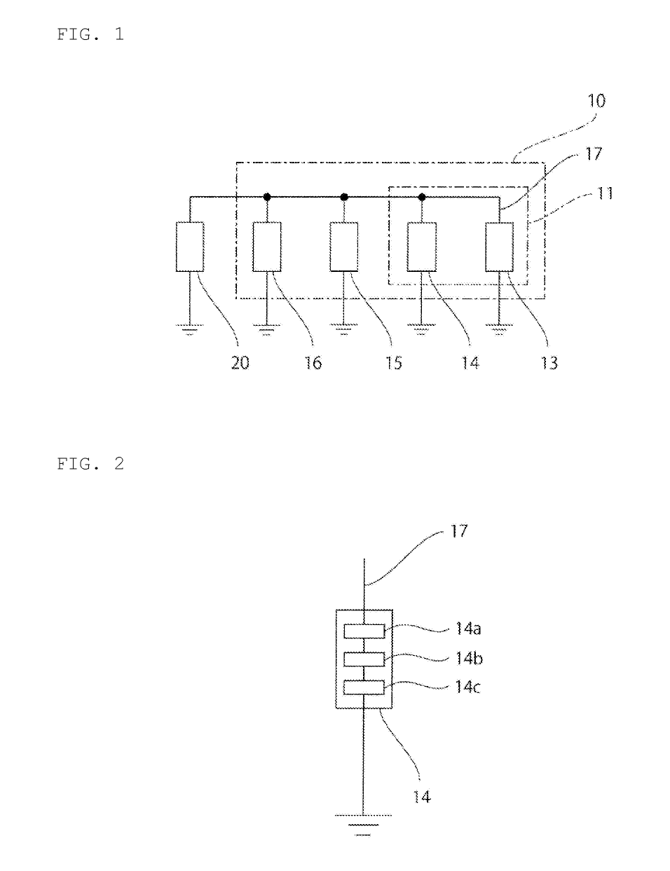

As shown in FIG. 1, an on-vehicle power supply device 10 is a device for use in an electric vehicle (EV: Electric Vehicle) or a vehicle equipped with an internal combustion engine. Specific, non-limiting, examples of a vehicle equipped with an internal combustion engine include, for example, idling stop (ISS) vehicles, hybrid electric vehicles (HEV: Hybrid Electric Vehicle), and plug-in hybrid vehicles (PHEV: Plug-in Hybrid Electric Vehicle).

The on-vehicle power supply device 10 is a device connected to an electrical load 20 such as an on-vehicle motor and used as a power supply for the electrical load 20. The on-vehicle power supply device 10 includes an on-vehicle battery 11, a regulator 15 as a constant voltage controller, and a generator (alternator) 16 which generates electricity. The generator 16, the regulator 15, and the on-vehicle battery 11 are connected in parallel.

The generator 16 can be, for example, an internal combustion engine or a motor that recycles regeneration energy during deceleration. The electricity generated by the generator 16 is supplied to both the electrical load 20 and the on-vehicle battery 11. The regulator 15 has the function of regulating the voltage supplied from the generator 16 to a constant voltage. In the present embodiment, an example will be explained where the regulator 15 has a charging voltage set to 14.4 V.

The on-vehicle battery 11 includes a lead storage battery 13 and a secondary battery 14 connected in parallel. It is to be noted that the on-vehicle battery 11 may have any configuration besides the lead storage battery 13 and the secondary battery 14. The on-vehicle battery 11 may further have, in addition to the lead storage battery 13 and the secondary battery 14, for example, a controller connected to the lead storage battery 13 and the secondary battery 14, for preventing abnormalities of the batteries, such as over discharge, overcharge, and overheat.

The lead storage battery 13 may have multiple lead storage batteries of unit cells connected in series or parallel. In the present embodiment, an example will be explained where the lead storage battery 13 has six lead storage batteries of unit cells connected in series. In the present embodiment, the lead storage battery 13 has a rated open voltage of 12 V. It is to be noted that the typical available open voltage range in the case of a 12 V-lead storage battery is 12.7 V or more and 12.8 V or less.

The secondary battery 14 is connected in parallel with the lead storage battery 13. In the illustrated embodiment the lead storage battery 13 and the secondary battery 14 are connected without any DC-DC converter interposed therebetween.

In the present embodiment, the secondary battery 14 is composed of lithium ion secondary batteries. More specifically, in the present embodiment, the secondary battery 14 is composed of multiple lithium ion secondary batteries connected in series on a power supply line 17. Even more specifically, in the present embodiment, as shown in FIG. 2, the secondary battery 14 is composed of three lithium ion secondary batteries 14a, 14b, 14c of three unit cells connected in series. However, the number of secondary batteries is not particularly limited. The number of secondary batteries is appropriately selected depending on the rated open voltage of the lead storage battery 13 and the like.

The capacity of the lithium ion secondary battery 14a, the capacity of the lithium ion secondary battery 14b, and the capacity of the lithium ion secondary battery 14c may be equal to or different from each other, but are preferably equal to each other. When the capacity of the lithium ion secondary battery 14a, the capacity of the lithium ion secondary battery 14b, and the capacity of the lithium ion secondary battery 14c are equal to each other, battery manufacturing lines can be brought into one, which is efficient.

The lithium ion secondary batteries 14a, 14b, 14c each have a positive electrode, a negative electrode, and a non-aqueous electrolytic solution. The positive electrode preferably includes, as a positive electrode active material, a spinel-type lithium-nickel-manganese oxide. The positive electrode further preferably includes, as a positive electrode active material, a spinel-type lithium-nickel-manganese oxide of a composition formula Li1+a[Mn2−a−x−yNixMy]O4 (0≦a≦0.3, 0.15≦x≦0.6, 0≦y≦0.3, M represents a metal element containing Ti). In this case, the lithium ion secondary batteries 14a, 14b, 14c are less likely to be deteriorated. For this reason, the frequency of replacing the lithium ion secondary batteries 14a, 14b, 14c can be reduced. Accordingly, the on-vehicle battery 11 can be reduced in cost.

The negative electrode includes, as a negative electrode active material, at least one of graphite, soft carbon, hard carbon, and an alloy-based material containing an Si element. The negative electrode preferably includes, as a negative electrode active material, at least one of soft carbon, hard carbon, and an alloy-based material containing an Si element. Examples of the alloy-based material containing the Si element include materials such as Si, Si alloys, and silicon oxides (SiOx, 0<x≦2), and composite materials of the foregoing materials with carbon materials.

The positive electrode and the negative electrode may, if necessary or desirable, each include a conduction aid, a binder, and the like. Specific examples of conduction aids used preferably include, for example, carbon black, graphite, soft carbon, hard carbon, vapor-grown carbon fibers (VGCF), and carbon tubes.

Specific examples of binders used preferably include, for example, various types of resins, such as polyvinylidene fluoride, polytetrafluoroethylene, polyolefin, polyacrylic acid, carboxymethyl cellulose, styrene-butadiene rubbers, polyimide, polyamideimide, and polyacrylonitrile.

The negative electrode may be pre-doped with lithium ions.

The non-aqueous electrolytic solution includes an electrolyte salt and an organic solvent.

Specific examples of electrolyte salts used preferably include, for example, LiPF6, LiClO4, LiBF4, LiCF3SO3, Li(CF3SO2)2N, Li(C2F5SO2)2N, Li(CF3)2N, and LiB(CN)4. One of these electrolyte salts may be used alone, or two or more thereof may be used in combination. The electrolyte salt concentration in the non-aqueous electrolytic solution is preferably 0.3 mol/L or more and 4 mol/L or less.

Specific examples of organic solvents used preferably include, for example, carbonate-based solvents, lactone-based solvents, sulfone-based solvents, nitrile-based solvents, ester-based solvents, ether-based solvents, and these organic solvents with some hydrogen thereof substituted with an element that is high in electronegativity, such as fluorine. One of these organic solvents may be used alone, or two or more thereof may be used in combination.

It is to be noted that the lithium ion secondary battery using a spinel-type lithium-nickel-manganese oxide as a positive electrode active material and using graphite, soft carbon, hard carbon, an alloy-based material containing an Si element as a negative electrode active material typically has an open voltage of approximately 3.0 V or higher and 4.8 V or lower in the available capacity range.

In the on-vehicle battery 11 with the lead storage battery 13 and secondary battery 14 connected in parallel without any DC-DC converter interposed therebetween, it is preferable that the open voltage of the secondary battery 14 meets the following condition (a), condition (b), and condition (c):

Condition (a): there is a point (open circuit voltage coincidence) within the available voltage range of the lead storage battery 13 where the open circuit voltage of the lead storage battery 13 is coincident with the open circuit voltage of the secondary battery 14.

Condition (b): in a condition where the open voltages of the lead storage battery 13 and the secondary battery 14 are charged up to a higher voltage than the open circuit voltage coincidence, the open circuit voltage of the secondary battery 14 is higher than the open circuit voltage of the lead storage battery 13 in the available capacity range of the secondary battery 14; and

Condition (c): the secondary battery 14 has a wide (e.g., 50% or greater) available capacity range in a range in which the open circuit voltage of the secondary battery 14 is equal to or higher than the lower limit of the available open voltage range of the lead storage battery 13, and equal to or lower than the charging voltage of the lead storage battery 13.

The open circuit voltage of the secondary battery 14 is set so as to satisfy the condition (a), thereby making it possible to make the terminal voltage of the lead storage battery 13 coincident with the terminal voltage of the secondary battery 14 in the case of discharge. Thus, the need to provide a DC-DC converter, which is conventionally considered to be essential, is eliminated. Accordingly, the on-vehicle battery 11 can be reduced in size, weight, and cost.

In addition, it is preferable for the open circuit voltage of the secondary battery 14 to change gradually within the available voltage range of the lead storage battery 13, from the perspective of preventing over discharge of the lead storage battery 13, that is, from the perspective of reduction in cost for reducing the frequency of replacing the lead storage battery 13.

The open voltage of the secondary battery 14 is set so as to satisfy the condition (b), thereby preferentially discharging the secondary battery 14 that has a higher open voltage than the lead storage battery 13 in a condition charged up to a higher voltage than the open voltage coincidence. Therefore, deterioration of the lead storage battery 13 can be suppressed and costs can be reduced.

The open voltage of the secondary battery 14 is set so as to satisfy the condition (c), thereby making it possible to use the capacity of the secondary battery 14 in an effective manner without using a DC-DC converter, and thus reduce the on-vehicle power supply device 10 in size, weight, and cost. In addition, as the available capacity range of the secondary battery 14 is relatively large, the capacity required for the secondary battery 14 can be reduced, thereby reducing the secondary battery 14 and the on-vehicle power supply device 10 in size, weight, and cost.

In recent years there has been increased demand for applying lithium ion second batteries to applications where it is necessary to have large capacities and high inputs and outputs. Accordingly, lithium ion second batteries using, as a positive electrode active material, a lithium-nickel-cobalt-manganese oxide that is larger in capacity per unit weight than spinel-type lithium-nickel-manganese oxides have come to be used widely.

In particular, second batteries for use in on-vehicle electric storage devices have been strongly required to have great input-output characteristics per unit time. For this reason, one skilled in the art considers, as a matter of course, that high-input/output lithium ion second batteries using a lithium-nickel-cobalt-manganese oxide as a positive electrode active material are preferred for on-vehicle electric storage devices. For example, a lithium ion secondary battery using LiNi5/10Co2/10Mn3/10O2 as a positive electrode active material and graphite as a negative electrode active material has an open voltage of approximately 2.5 V or higher and 4.2 V or lower in the available capacity range.

When a secondary battery that satisfies the conditions (a) and (b) is intended to be configured with the use of a lithium ion secondary battery using LiNi5/10Co2/10Mn3/10O2 as a positive electrode active material and graphite as a negative electrode active material, there is a need to connect four lithium ion secondary batteries in series.

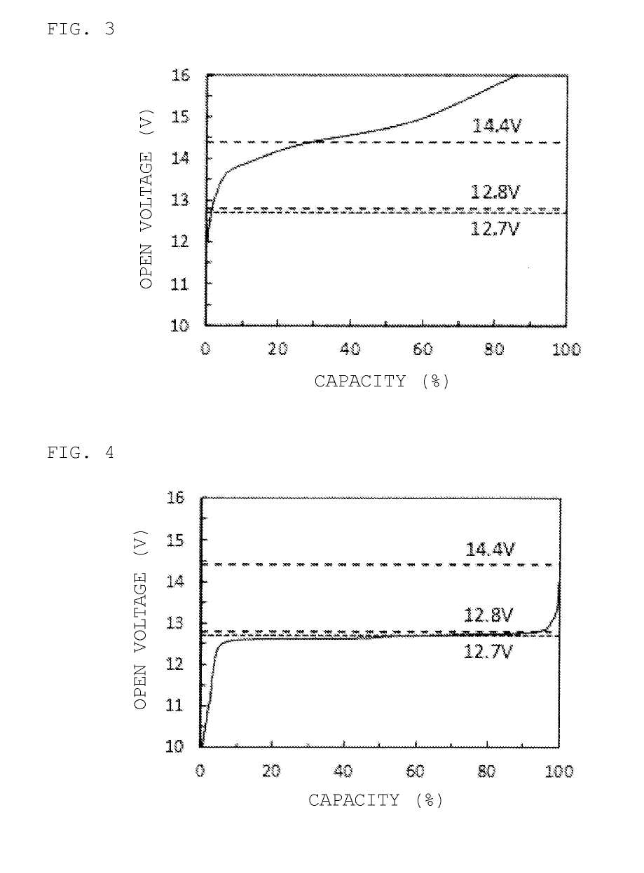

FIG. 3 shows a charge/discharge curve of a lithium ion secondary battery obtained by connecting, in series, four lithium ion second batteries using LiNi5/10Co2/10Mn3/10O2 as a positive electrode active material and graphite as a negative electrode active material. As shown in FIG. 3, in the case of the foregoing lithium ion secondary battery, the open voltage of the battery is higher than the voltage range of the condition (c) in most of its available capacity range (i.e., for capacities over approximately 30 percent). Therefore, when this lithium ion secondary battery is connected in parallel with a lead storage battery, the battery is charged only up to a capacity on the order of 30%. Accordingly, there is a need to either transform electric power with a DC-DC converter disposed between the lithium ion secondary battery and the lead storage battery or increase the capacity of the lithium ion secondary battery. However, since the DC-DC converter produces heat when transforming electric power, there is a need to provide a mechanism for cooling the DC-DC converter. As just described, for a lithium ion secondary battery using a lithium-nickel-cobalt-manganese oxide as a positive electrode active material and graphite as a negative electrode active material, there is a need to either provide both a DC-DC converter and a cooling mechanism therefor, or increase the capacity of the lithium ion secondary battery, in addition to the need to connect four batteries in series, thereby increasing the on-vehicle electric storage device in size, weight, and cost.

Lithium ion second batteries which have great input-output characteristics include lithium ion second batteries using, as a negative electrode active material, a lithium titanate represented by Li4Ti5O12. For example, a lithium ion secondary battery using Li4Ti5O12 as a negative electrode active material and a spinel-type lithium-nickel-manganese oxide as a positive electrode active material has an open voltage of approximately 3.0 V or higher and 3.2 V or lower in the available capacity range. For this reason, when a secondary battery that satisfies the condition (a) and (b) is intended to be configured with the use of the foregoing lithium ion secondary battery, there is a need to connect four lithium ion second batteries in series.

FIG. 4 shows a charge/discharge curve of a lithium ion secondary battery obtained by connecting, in series, four lithium ion second batteries using Li4Ti5O12 as a negative electrode active material and a spinel-type lithium-nickel-manganese oxide expressed by a composition formula Li1.1[Ni0.45Mn1.35Ti0.2]O4 as a positive electrode active material. As shown in FIG. 4, in the case of the foregoing lithium ion secondary battery, the open terminal voltage is lower than the voltage range of the condition (c) in most of the available capacity range. Therefore, there is a need to transform electric power with a DC-DC converter disposed between the lithium ion secondary battery and the lead storage battery. As just described, for a lithium ion secondary battery using Li4Ti5O12 as a negative electrode active material and a spinel-type lithium-nickel-manganese oxide as a positive electrode active material, there is a need to provide both a DC-DC converter and a cooling mechanism therefor, in addition to the need to connect four second batteries in series, thereby increasing the on-vehicle electric storage device in size, weight, and cost.

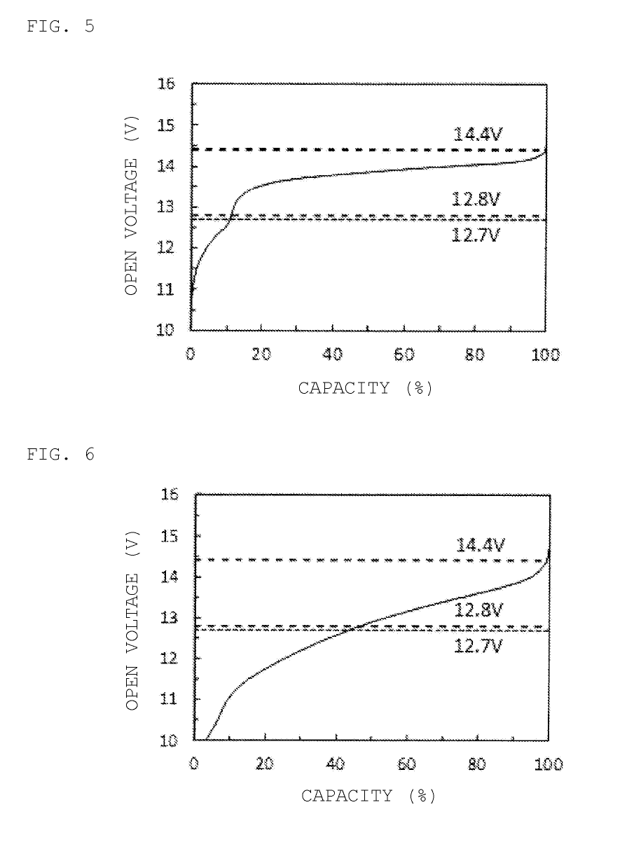

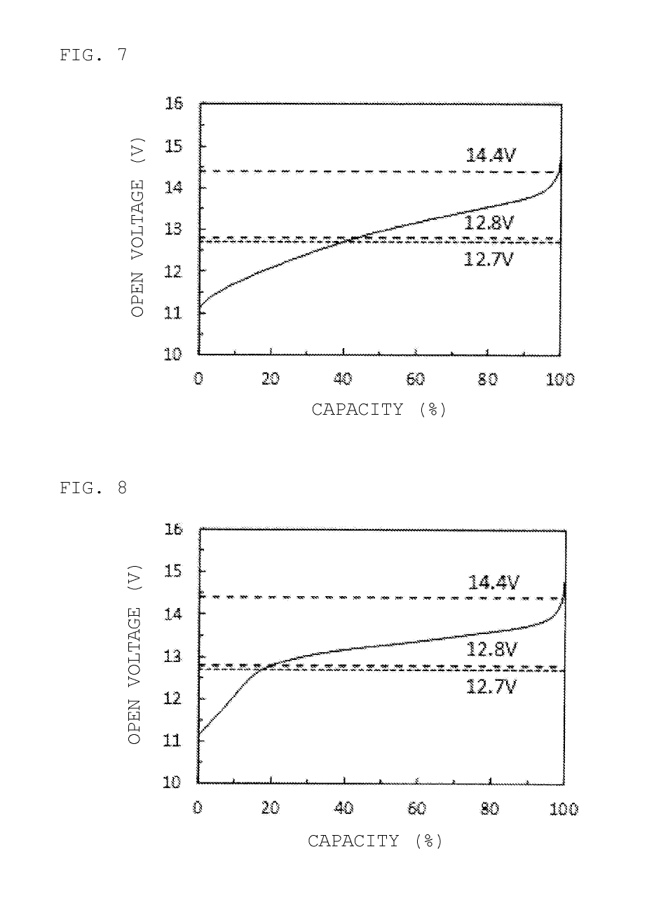

FIG. 5 shows a charge/discharge curve of the secondary battery 14 (lithium ion secondary battery) obtained by connecting, in series, the three lithium ion secondary batteries (unit cells) 14a, 14b, 14c using, for a positive electrode active material, a spinel-type lithium-nickel-manganese oxide expressed by a composition formula Li1.1[Ni0.45Mn1.35Ti0.2]O4, and graphite for a negative electrode active material. FIG. 6 shows a charge/discharge curve of the secondary battery 14 (lithium ion secondary battery) obtained by connecting, in series, the three lithium ion secondary batteries (unit cells) 14a, 14b, 14c using, for a positive electrode active material, a spinel-type lithium-nickel-manganese oxide expressed by a composition formula Li1.1[Ni0.45Mn1.35Ti0.2]O4, and soft carbon for a negative electrode active material. FIG. 7 shows a charge/discharge curve of the secondary battery 14 (lithium ion secondary battery) obtained by connecting, in series, the three lithium ion secondary batteries (unit cells) 14a, 14b, 14c using, for a positive electrode active material, a spinel-type lithium-nickel-manganese oxide expressed by a composition formula Li1.1[Ni0.45Mn1.35Ti0.2]O4, and hard carbon for a negative electrode active material. FIG. 8 shows a charge/discharge curve of the secondary battery 14 (lithium ion secondary battery) obtained by connecting, in series, the three lithium ion secondary batteries (unit cells) 14a, 14b, 14c using, for a positive electrode active material, a spinel-type lithium-nickel-manganese oxide expressed by a composition formula Li1.1[Ni0.45Mn1.35Ti0.2]O4, and Si for a negative electrode active material.

As shown in FIGS. 5 to 8, according to the present embodiment, 50% or more of the available capacity range falls within condition (c) when connecting, in series, the three lithium ion secondary batteries (unit cells) 14a, 14b, 14c that satisfy the conditions (a) and (b). Therefore, in the on-vehicle power supply device 10, there is not always a need to provide a DC-DC converter or a cooling system therefor. In addition, the number of lithium ion secondary batteries in series can be three, thus allowing the secondary battery 14 (lithium ion secondary battery) and the on-vehicle power supply device 10 to be reduced in size, weight, and cost.

In addition, in the condition (a), from the perspective of preventing over discharge of the lead storage battery 13, the open terminal voltage of the secondary battery 14 preferably changes gradually in the open terminal voltage range of 12.7 V or more and 12.8 V or less, which is the available voltage range of the lead storage battery 13. As shown in FIGS. 5 to 8, when soft carbon, hard carbon, or Si is used for the negative electrode active material, the change in open voltage is more gentle in the open voltage range of 12.7 V or more and 12.8 V or less, than the case where graphite is used for the negative electrode active material. Therefore, it is preferable for the negative electrode active material to include therein at least one of soft carbon, hard carbon, and an alloy-based material containing an Si element, from the perspective of preventing over discharge of the lead storage battery.

### DESCRIPTION OF REFERENCE SYMBOLS

10: on-vehicle power supply device

11: on-vehicle battery

13: lead storage battery

14: secondary battery

14a, 14b, 14c: lithium ion secondary battery

15: regulator

16: generator

17: power supply line

20: electrical load

1. A battery comprising:
a lead storage battery; and
a lithium ion secondary battery connected in parallel with the lead storage battery, the secondary battery having:
a positive electrode comprising a positive electrode active material including a spinel-type lithium-nickel-manganese oxide; and
a negative electrode comprising a negative electrode active material including at least one of graphite, soft carbon, hard carbon, and an alloy-based material containing an Si element.

2. A battery according to claim 1, wherein the negative electrode active material consists of at least one of soft carbon, hard carbon, and an alloy-based material containing an Si element.

3. A battery according to claim 1, wherein the positive electrode active material comprises a spinel-type lithium-nickel-manganese oxide of a composition formula Li₁₊ₐ[Mn_{2-a-x-y}NiₓM_{y}]O₄, M being a metal element containing Ti, 0≦a≦0.3, 0.15≦x≦0.6, and 0≦y≦0.3.

4. A battery according to claim 1, wherein the secondary battery has three secondary batteries connected in series.

5. A battery according to claim 4, wherein the capacities of three secondary batteries are equal to each other.

6. A battery according to claim 4, wherein the open circuit voltage of the lead storage battery is coincident with the open circuit voltage of the secondary battery.

7. A battery according to claim 6, wherein the lead battery and the secondary battery have a relationship wherein when the open voltages of the lead storage battery and the secondary battery are charged up to a voltage that is higher than their open circuit voltages, the open circuit voltage of the secondary battery is higher than the open circuit voltage of the lead storage battery within the available capacity of the secondary battery.

8. A battery according to claim 7, wherein the secondary battery has a capacity range of 50% or greater in which the open circuit voltage of the secondary battery is equal to or higher than the lower limit of the available open voltage range of the lead storage battery.

9. A battery according to claim 8, wherein the secondary battery has a capacity range of 50% or greater in which the open circuit voltage of the secondary battery is equal to or lower than the charging voltage of the lead storage battery.

10. A combination comprising a battery and a generator connected to the battery, the battery comprising:
a lead storage battery; and
a lithium ion secondary battery connected in parallel with the lead storage battery, the secondary storage secondary battery having:
a positive electrode comprising a positive electrode active material including a spinel-type lithium-nickel-manganese oxide; and
a negative electrode comprising a negative electrode active material including at least one of graphite, soft carbon, hard carbon, and an alloy-based material containing an Si element.

11. A combination according to claim 10, wherein the negative electrode active material consists of at least one of soft carbon, hard carbon, and an alloy-based material containing an Si element.

12. A combination according to claim 10, wherein the positive electrode active material comprises a spinel-type lithium-nickel-manganese oxide of a composition formula Li₁₊ₐ[Mn_{2-a-x-y}NiₓM_{y}]O₄, M being a metal element containing Ti, 0≦a≦0.3, 0.15≦x≦0.6, and 0≦y≦0.3.

13. A combination according to claim 10, wherein the secondary battery has three secondary batteries connected in series.

14. A combination according to claim 13, wherein the capacities of three secondary batteries are equal to each other.

15. A combination according to claim 13, wherein the open circuit voltage of the lead storage battery is coincident with the open circuit voltage of the secondary battery.

16. A combination according to claim 15, wherein the lead battery and the secondary battery have a relationship wherein when the open voltages of the lead storage battery and the secondary battery are charged up to a voltage that is higher than their open circuit voltages, the open circuit voltage of the secondary battery is higher than the open circuit voltage of the lead storage battery within the available capacity of the secondary battery.

17. A combination according to claim 16, wherein the secondary battery has a capacity range of 50% or greater in which the open circuit voltage of the secondary battery is equal to or higher than the lower limit of the available open voltage range of the lead storage battery.

18. A combination according to claim 17, wherein the secondary battery has a capacity range of 50% or greater in which the open circuit voltage of the secondary battery is equal to or lower than the charging voltage of the lead storage battery.
